(19) United States
(12) Patent Application Publication
(10) Pub. No.: US 2014/0188550 A1
(43) Pub. Date: Jul. 3, 2014

(54) Provision Of Customer Attributes To A Person

(71) Applicant: David Patterson, Berkeley, CA (US)

(72) Inventor: David Patterson, Berkeley, CA (US)

(73) Assignee: Wal-Mart Stores, Inc., Bentonville, AR (US)

(21) Appl. No.: 13/730,626

(22) Filed: Dec. 28, 2012

(51) Int. Cl. G06Q 30/02

(52) U.S. Cl. CPC G06Q 30/0201
USPC 705/7.29

(57) ABSTRACT

The present disclosure extends to methods, systems, and computer program products for establishing an attribute template for a customer for distribution to recipients. In operation, customer information is received and placed as attributes in a template that is then made available to predetermined recipients.

### BACKGROUND

Advances in technology have allowed large amounts of information to be gathered in the form of data about the lives and behaviors of customers. This information may be valuable to a customer, and may represent much about the customer's life. Because of the life history that such information could portray, the customer may desire to share the information with other persons, but in its raw form it is hard to convey in a sensible manner such that the information can be appreciated by a friend, family member, coworker and even a stranger. A stranger could be someone that the customer has just met online, or may meet online in the future, and to whom the customer desires to make a more detailed introduction.

What is needed are methods and systems that are efficient at organizing relevant information about customers' lives, and also effective methods and systems to convey this information in a form that other parties can appreciate. As will be seen, the disclosure provides methods and systems that can do this in an efficient and elegant manner.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 illustrates an example block diagram of a computing device;

FIG. 2 illustrates an example retail location and computer architecture that facilitates different implementations described herein;

FIG. 3 illustrates a flow chart of an example method according to one implementation;

FIG. 4A illustrates a flow chart of an example method according to one implementation;

FIG. 4B illustrates a flow chart of an example method according to one implementation; and

FIG. 5 illustrates a flow chart of an example method according to one implementation.

### DETAILED DESCRIPTION

The present disclosure extends to methods, systems, and computer program products for conveying information about customer attributes based on customer provided information and other related information from the customer's activity on a merchant's networks or within a merchant's retail location that may represent an approximate life history of the customer. In the following description of the present disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure.

Implementations of the present disclosure may comprise or utilize a special purpose or general-purpose computer including computer hardware, such as, for example, one or more processors and system memory, as discussed in greater detail below. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures that can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. It should be noted that any of the above mentioned computing devices may be provided by or located within a brick and mortar location. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS), and deployment models (e.g., private cloud, community cloud, public cloud, hybrid cloud, or any suitable service type model now known to those of ordinary skill in the field, or later discovered). Databases and servers described with respect to the present disclosure can be included in a cloud model.

As used herein, the terms “customer” and “user” are used interchangeably, and are intended to denote that a customer can be both contemplated in a brick and mortar retail location as well as a customer who is a user on a computing device.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

As used herein, the terms “life history” are intended to represent customer attributes over time that may be used by the customer to convey information about the customer's life over time. A life history, may be represented by attributes that span the known life of the customer, or may represent only a portion of the customer's life.

As used herein, the term “provision” is intended to represent the act of providing access (either electronic or physical) to a customer template to a recipient, whether it is the actually conveyance of a template (either physically or electronically) to a recipient or allowing access to the template over a network.

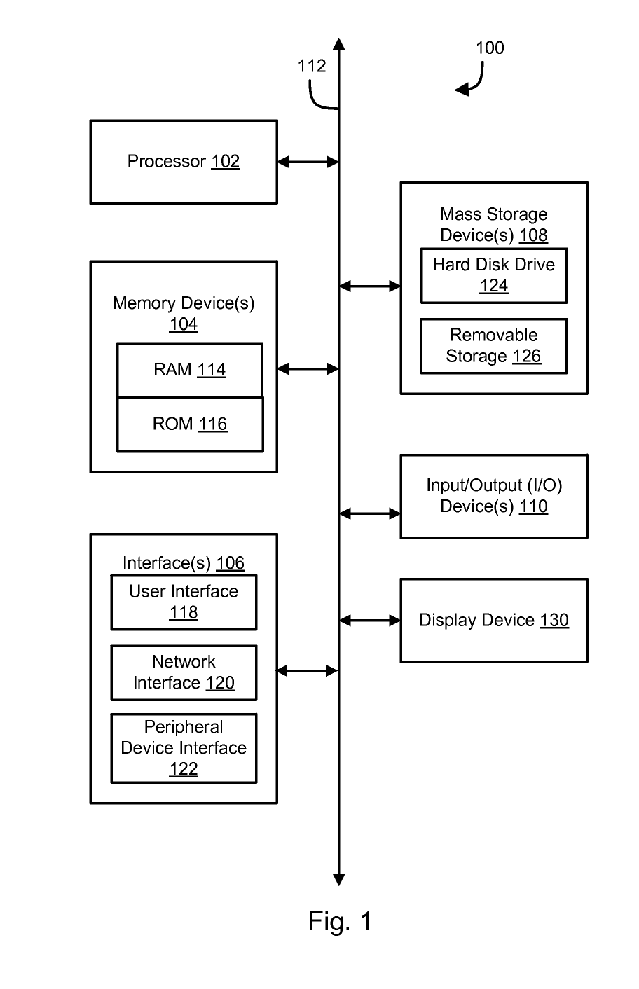

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid-state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 may include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

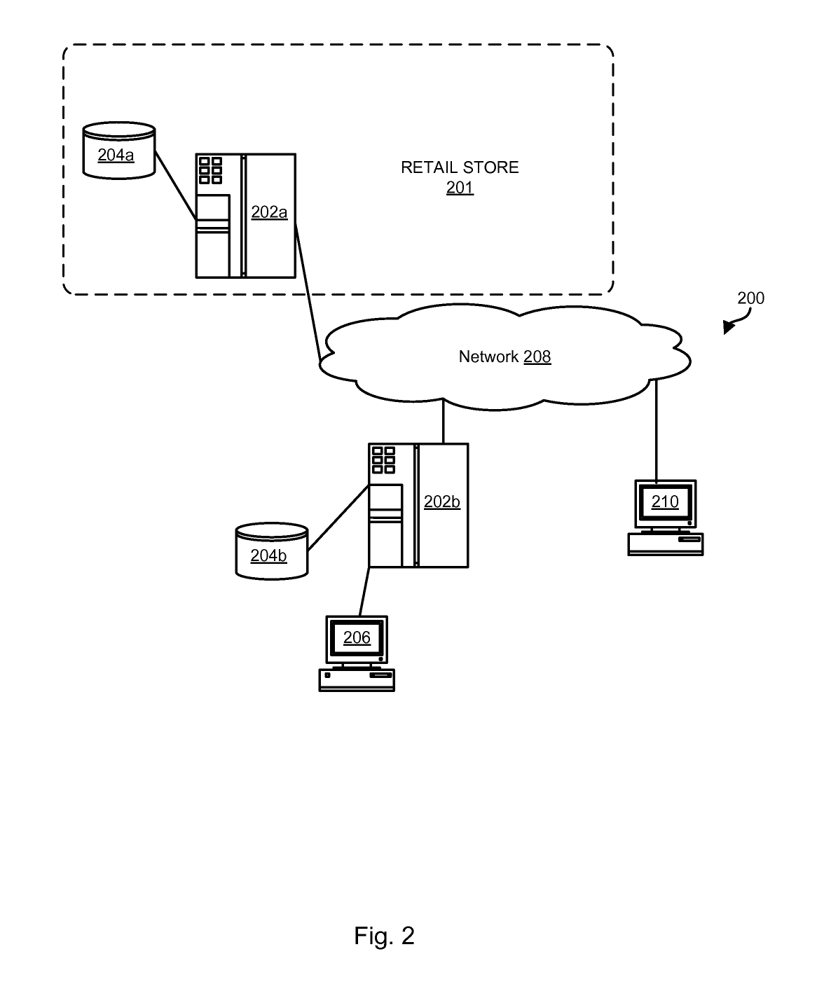

FIG. 2 illustrates an example of a computing environment 200 and a brick and mortar retail location 201 suitable for implementing the methods disclosed herein. In some implementations, a server 202a provides access to a database 204a in data communication therewith, and may be located and accessed within a brick and mortar retail location. The database 204a may store customer attribute information such as a user profile as well as a list of other user profiles of friends and associates associated with the user profile. The database 204a may additionally store attributes of the user associated with the user profile. The server 202a may provide access to the database 204a to users associated with the user profiles and/or to others. For example, the server 202a may implement a web server for receiving requests for data stored in the database 204a and formatting requested information into web pages. The web server may additionally be operable to receive information and store the information in the database 204a.

A server 202b may be associated with a merchant or by another entity or party providing gift recommendation services. The server 202b may be in data communication with a database 204b. The database 204b may store information regarding various products. In particular, information for a product may include a name, description, categorization, reviews, comments, price, past transaction data, and the like. The server 202b may analyze this data as well as data retrieved from the database 204a in order to perform methods as described herein. An operator or customer/user may access the server 202b by means of a workstation 206, which may be embodied as any general purpose computer, tablet computer, smart phone, or the like.

The server 202a and server 202b may communicate with one another over a network 208 such as the Internet or some other local area network (LAN), wide area network (WAN), virtual private network (VPN), or other network. A user may access data and functionality provided by the servers 202a, 202b by means of a workstation 210 in data communication with the network 208. The workstation 210 may be embodied as a general purpose computer, tablet computer, smart phone or the like. For example, the workstation 210 may host a web browser for requesting web pages, displaying web pages, and receiving user interaction with web pages, and performing other functionality of a web browser. The workstation 210, workstation 206, servers 202a-202b, and databases 204a, 204b may have some or all of the attributes of the computing device 100.

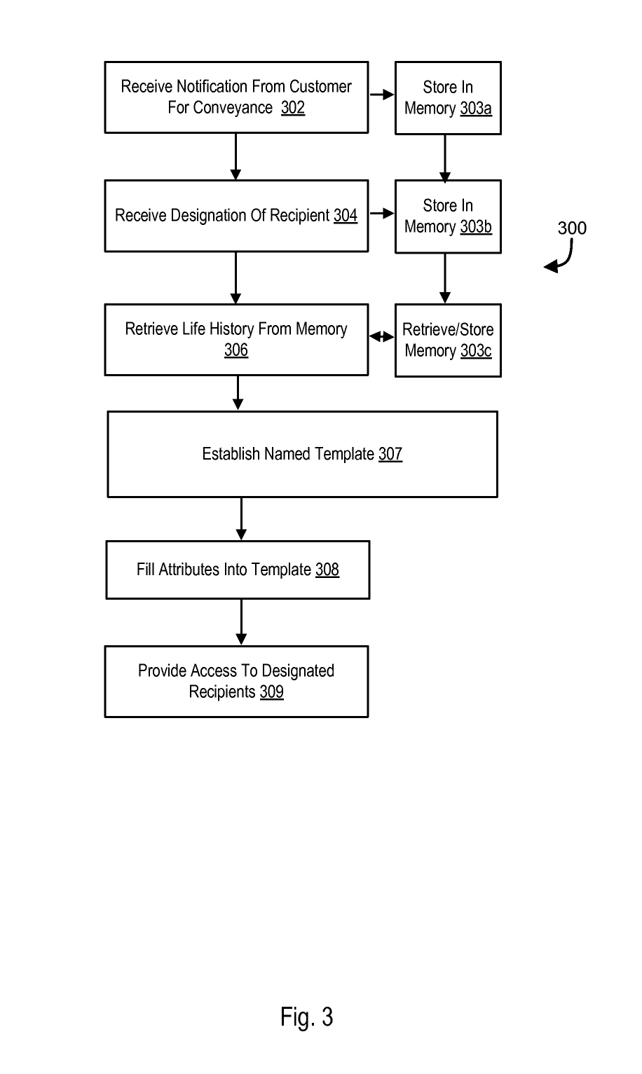

With reference primarily to FIG. 3, an implementation of a method 300 for creating a template suitable for conveying customer attributes forming a life history to a designated person (recipient) will be discussed. FIG. 1 and FIG. 2 may be referenced secondarily during the discussion in order to provide hardware support for the implementation. The disclosure aims to disclose methods and systems to allow a customer to designate a recipient of a template filled with attributes, that when assembled, form a life history suitable for conveyance to the designated recipient.

The method 300 may include the database 204a (or any suitable memory device disposed in communication with the network 208) receiving notification 302 from a customer that the customer would like to convey, or allow access to, the customer's attributes to a third party recipient. At 303a the notification may be stored in memory associated with a customer profile within computing environment 200. The notification by the customer may be solicited by a merchant, and may be received over a computer network that both the customer and merchant are connected to. Additionally, the notification may be made in person at a retail location of the merchant. Either on-line or in-store, a database 204a (or any suitable memory device disposed in communication with the network 208) used in performing the method 300 may receive a designated recipient 304 to whom a template of attributes can be distributed.

The designation of the recipient by the customer may be made by directly communicating with a representative of the merchant in real time or with a communication device to enable delayed communication such as via email or other suitable communication means, or on-line from a web page type interface having input and output options as discussed above. The customer may also determine a list of possible attributes to be organized within a template for the designated recipient that may portray a life history of the customer and may include such things as: identities, documents, images of the customer, home address, work history, and/or any other type of attribute information normally used to establish a person's life history. The selection may be made by common computer I/O means such as, example I/O device(s) that may include cursor control devices, keyboards, keypads, microphones, monitors or other display devices, speakers, printers, network interface cards, modems, lenses, CCDs or other image capture devices, and the like. The designation of a recipient at 304 made by a customer may be stored in memory 303b within computing environment 200.

At 306, attributes representative of the customer's life history may be retrieved from storage within computing environment 200. The life history attributes may have been entered by the customer previously, or may be entered concurrently with the notification for conveyance at 302. In an implementation, attributes that may be used in a template may be from documents provided by the customer that have been saved in the memory 303c on a merchant's server as discussed in greater detail below.

At 307, a template may then be generated that may be correlated to a form that is specified by the customer for the designated recipient. In other words, a customer may desire that a designated recipient only receive a certain category of attributes representing the customer's life history. Furthermore, a customer may wish to have the attributes organized in a certain way within the template. For example, if a customer includes attributes such as photos within a template, a customer may desire that the photos appear in the template in an order based on the date the photo was taken.

It should be noted that a template may comprise attributes in various forms. For example, a template may be predetermined such that it contains such information as: age, education, income, image of customer, gender of customer, home ownership, and/or marital status. An implementation, may comprise a template that contains documents, or portions of documents, where the customer specifies the type and order of the documents in the template. A non-limiting example may be a customer that is seeking to reintroduce itself to an old friend. In the present example, the customer may desire a template having documents and photos that progress from the time the customer lost contact with the recipient up to the current day. In other words, the template form may depend somewhat on a characteristic of the recipient and/or the relationship between the customer and the recipient. It can be seen by those in the art, that a template conveying a life history, or a portion of a life history, may be small or may be very large, and that a template can vary depending on the desires of the customer and characteristics of the designated recipient.

In an implementation, the template may comprise the notification recorded into memory at 303a within computing environment 200, along with the designation of the recipient, recorded into memory at 303b within computing environment 200.

Once the template has been established as discussed above, the method may involve the process of the computing device 100 within a computing environment 200 then filling in the template with the desired attributes representing a life history at 308. At 309, access may then be granted to the designated recipient. It should be noted, that recipients may be allowed to access the attribute information of a customer on the merchant's sever over connected networks, or alternatively, the merchant may actually convey the template to the recipients such that the recipients have the template within their own computer system.

In an implementation, a customer may have designated a stranger (or even someone they have only met digitally online, or are about to meet online) as a recipient. A stranger could be someone that the customer has just met online through, for a non-limiting example, a website that promotes social activities such as dating, friendship, and the like. Non-limiting examples of social websites are: Match.com™, eHarmony™, JDate™ and Chemistry.com™, to name a few. Accordingly, the customer may desire to make a more detailed introduction to this relative stranger, wherein the introduction (template) may contain attributes that may be verified by the merchant. In an instance, in which the customer and recipient have not exchanged contact information, or even real names, the template of attributes may not contain the customers name or contact information.

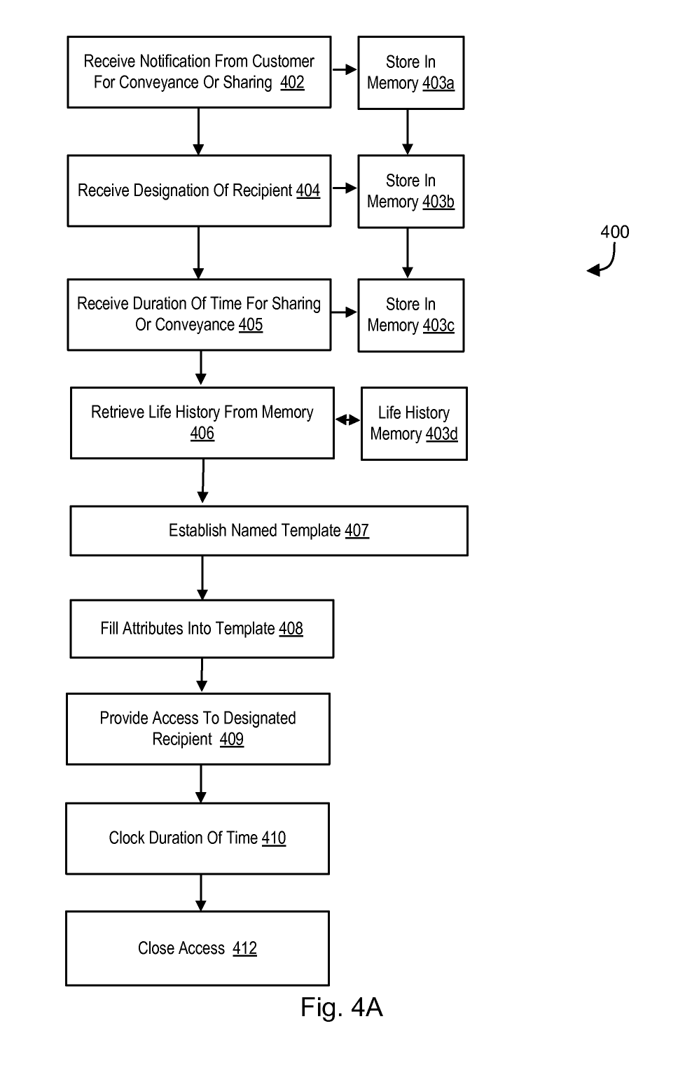

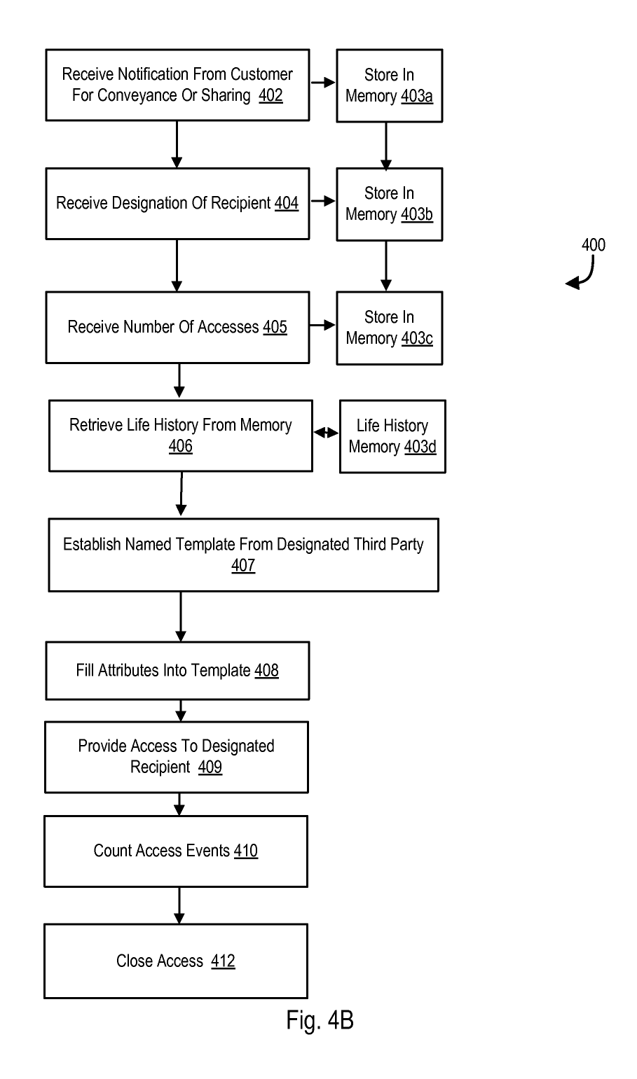

With reference primarily to FIG. 4A, an implementation of a method 400 for creating a template for conveying customer attributes to a recipient wherein a designated recipient may have limited access to the template will be discussed. In other words, the customer can specify the duration that a recipient, or plurality of recipients, will have access to the customer template. FIG. 1 and FIG. 2 may be referenced secondarily during the discussion in order to provide hardware support for the implementation.

Accordingly, the method 400 may include 204a (or any suitable memory device disposed in communication with the network 208) receiving notification 402 from a customer that the customer would like to convey to a specific recipient. At 403a the notification may be stored in memory associated with a customer profile stored within computing environment 200. The notification by the customer may be solicited by a merchant, and may be received over a computer network 208 that both the customer and merchant are connected to. Additionally, the notification may be made in person at a retail location of the merchant in real time or with a communication device to enable delayed communication such as via e-mail or other suitable communication device, or on-line from a web page type interface having input and output options as discussed above. Either on-line or in-store, a data base 204a (or any suitable memory device disposed in communication with the network 208) used to perform the method 400 may receive a designation of recipients at 404.

In an implementation, the customer may be designating the desired third party recipients from a list presented to them by a merchant. As discussed above, the designated recipients may share characteristics that may determine the type of attributes to be included in a template that may be representative of a life history of the customer. For example, in an implementation, the recipients may share a characteristic such as place of work. In the present implementation, the customer may also work at the same place of work as the designated recipients, and may want to convey attributes in a template suitable for coworkers. At 404, the designation made by a customer for the recipients they wish to allow access to is received and stored in memory 403b within computing environment 200.

At 405, a duration of time that the designated recipients are allowed access may be specified by the customer and recorded into memory 403c within environment 200. It should be noted, that third party recipients may be allowed to access the attribute information of the customer, or alternatively, the merchant may actually convey the template to the recipients such that the recipients receive a file on to their computer that is connected over the network 208. In either happenstance, once the duration has elapsed, access to the attribute data is to be terminated. In an implementation where the attributes are conveyed in a template, the template file may simply be deleted to terminate access. Any suitable manner known to those skilled or having ordinary skill in the field, for terminating a third party recipient's access to the attribute data, such when the duration specified or designated by the customer has occurred, may be used. In an implementation where access is granted to a third party recipient, the access may simply be denied once the duration of time has elapsed. In an implementation, access by the designated recipient may depend on non-time related factors, such as, whether the customer continues to work at the work place. Accordingly, if the customer were to change places of work the customer may wish to stop access to the template by the previous coworkers.

At 406, computing device 100, within a computing environment 200 may cause the method 400 to retrieve life history attributes from memory 403d. The life history attributes may have been entered by the customer previously, or may be entered concurrently with the notification for conveyance at 402. In an implementation, attributes that may be used in a template may be derived from documents provided by the customer that have been saved in the memory 403d on a merchant's server located within computing environment 200.

At 407 a template may be established or generated that may be correlated to a form that is specified by the customer for the designated recipient. In other words, a customer may desire that a designated recipient only receive a certain category of attributes representing the customer's life history. Furthermore, a customer may wish to have the attributes organized in a certain way within the template. For example, if a customer includes attributes such as work achievements within a template, a customer may desire that the work achievements appear in the template in an order based on the date the work took place.

It should be noted that a template having work related attributes therein may comprise attributes in various forms and stored in memory 403d of computing environment 200. For example, a work related template may be predetermined such that it contains such information as: education, image of customer, and work history/experience. An implementation, may comprise a template that contains work related documents and publications, or portions of documents, wherein the customer specifies the type and order of the documents in the template so that it can be provisioned and conveyed to the recipient in a meaningful way to a recipient.

Additionally, the template may comprise the notification recorded into memory at 403a, the designation of recipients recorded into memory at 403b, and the duration of access recorded into memory 403c, all within computing environment 200.

Once the template has been established as discussed above, the template may then be filled in with the desired attributes representing a life history at 408. At 409, access may then be granted to the designated recipients and at 410 a clock begins to run for the duration of time designated at 405 of method 400. The clock may run automatically within the computing system of a network and the clock may be a commonly used timing circuit within the computing environment 200. At 412, access to the template may be closed to the third party recipients once the duration of time has elapsed as discussed above.

Any suitable manner known to those skilled or having ordinary skill in the field, for terminating a recipient's access to the attribute data, such when the duration specified by the customer has occurred, may be used.

With reference primarily to FIG. 4B, an implementation of a method 400 for creating a template for conveying customer attributes to a recipient wherein a designated recipient may be limited to a certain number of access events for the template will be discussed. In other words, the customer can specify the number times that a recipient, or plurality of recipients, may access the customer template. FIG. 1 and FIG. 2 may be referenced secondarily during the discussion in order to provide hardware support for the implementation.

Accordingly, computing device 100 within in a computing environment 200 utilized by the method 400, may perform the process of receiving notification 402 from a customer that the customer would like to convey to a specific recipient. At 403a the notification may be stored in memory associated with a customer profile stored on a merchant's server. The notification by the customer may be solicited by a merchant, and may be received over a computer network that both the customer and merchant are connected to. Additionally, the notification may be made in person at a retail location of the merchant in real time or with a communication device to enable delayed communication such as via email or other suitable communication means. Either on-line or in-store, the method 400 may receive a designation of recipients at 404.

In an implementation, the customer may be designating the desired recipients from a list presented to them by a merchant. The designated recipients may share characteristics that may determine the type of attributes to be included in a template that may be representative of a life history of the customer. For example, in an implementation, the recipients may share a characteristic such as family relation. In the present implementation, the customer may also be related, and may want to convey attributes in a template suitable for family members. At 404, the designation made by a customer for the recipients they wish to allow access to is received and stored in memory 403b of the computing environment 200.

At 405, a number of access events that the designated recipients are allowed access to a customer template may be specified by the customer and recorded into memory 403c of computing environment 200. It should be noted, that in an implementation, recipients may be allowed to access the attribute information of the customer template while on a merchant controlled server. Alternatively, the merchant may actually convey the template to the recipients such that the recipients receive a file on to their computer. In either happenstance, once the predetermined number of access events has been reached, access to the attribute data is to be terminated. Accesses events may be counted by any computer counting circuit or computer process within computing environment 200. In an implementation where the attributes are conveyed in a template, the template file may simply be deleted. In an implementation where access is granted to a third party recipient, the access may simply be denied once the number of access events has been reached.

At 406, the method 400 may retrieve life history attributes from memory 403d. The life history attributes may have been entered by the customer previously, or may be entered concurrently with the notification for conveyance at 402. In an implementation, attributes that may be used in a template may be derived from documents provided by the customer that have been saved in the memory 403d on a merchant's server within computing environment 200.

At 407 a template be established or generated that may be correlated to a form that is specified by the customer for the designated recipient. In other words, a customer may desire that a designated recipient only receive a certain category of attributes representing the customer's life history. Furthermore, a customer may wish to have the attributes organized in a certain way within the template.

It should be noted that a template having family related attributes therein may comprise attributes in various forms and stored in memory 403d of computing environment 200. An implementation, may comprise a template that contains family related documents and publications, or portions of documents, wherein the customer specifies the type and order of the documents in the template so that it can be provisioned and conveyed to the recipient in a meaningful way.

Additionally, the template may comprise the notification recorded into memory at 403a, and the designation of recipients recorded into memory at 403b, and the limitation on access recorded into memory 403c, wherein all the above memory is within of computing environment 200.

Once the template has been established as discussed above, the template may then be filled with the desired attributes representing a life history at 408. At 409, access may then be granted to the designated recipients and at 410 a counter begins to run for the duration of time designated at 405 of method 400. At 412, access to the template may be closed to the recipients once the count of access events is reached as discussed above.

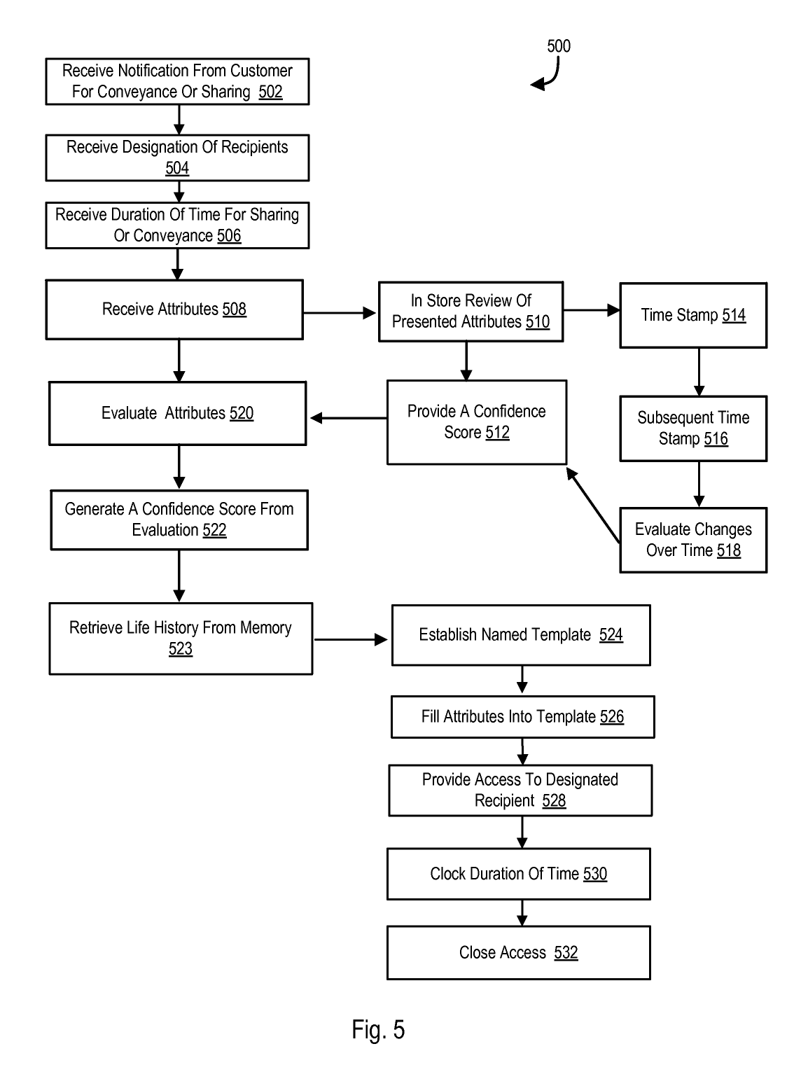

With reference primarily to FIG. 5, an implementation of a method 500 for creating a template for conveying customer attributes in a template that represents a life history that may be evaluated over time for the quality of the attributes within the template, will be discussed. FIG. 1 and FIG. 2 may be referenced secondarily during the discussion in order to provide hardware support for the implementation, and the connections and interrelatedness within the networking and computing relationships described above in discussion of FIG. 3 are hereby deemed to apply to the following descriptions in relation to FIG. 5.

Accordingly, the method 500 may include receiving notification 502 from a customer that the customer would like to convey, or allow access to, the template comprising the customer's attributes. The notification by the customer may be solicited by a merchant, and may be received over a computer network that both the customer and merchant are connected to. Additionally, the notification may be made in person at a retail location of the merchant. Either on-line or in-store, the method 500 may receive a designation or selection of recipients 504 for the desired possible third party recipients.

In an implementation, the customer may be designating the desired third party recipients from a list presented to them by a merchant. The designation by the customer may be made by directly communicating with a representative of the merchant, or may be made on-line from a web page type interface having input and output options as discussed above. As discussed above, the customer may determine a template of desired attributes to be conveyed to specific recipients based on characteristics of the recipients (or relation to the recipients) and the nature of information that the customer would like to share with such recipients.

At 506, a duration of time (or other limiting factor) that the designated recipients are allowed access to the template may be specified by the customer and recorded into memory. It should be noted, that recipients may be allowed to access the template of a user, or alternatively, the merchant may actually provision and convey the template to the recipients. In either happenstance, once the designated limiting factor has elapsed, access to the template is to be terminated.

At 508 of method 500, attributes may be input into the system by a customer or by receiving attribute information from other sources within the computing environment 200. In an implementation, various documents may be presented by a customer either in person at a retail location, or on-line wherein the attribute information is presented digitally. Furthermore, the attribute information from a customer may be digital in form and may comprise digital copies of such things as: State issued ids, legal documents, images of the customer, utility bills, home address, work history, pay check stubs, car registrations, and/or any other type of attribute information normally used to establish a person's identity. Additionally, a customer/user at a computer terminal may be able to enter attribute data in order to fill-in fields that represent the selection of attributes to be conveyed within a template. The information provided, either digitally or in the retail location, may then be reviewed 510 for content and quality. The review may be performed by a system and/or a representative of the merchant.

For a non-limiting example, a utility bill may be presented by a customer to provide attributes, and a digital copy may be received from the customer over the network 208. A merchant representative or a computer and/or server may review 510 the utility bill for customer attribute information and store the information on a merchant's server. The evaluation may be to authenticate the utility bill as real, and/or gather information from the utility bill such as name, address, usage, length of time for billing relationship, and other like information. In the present example, the system may then generate a confidence score 512 for the utility bill based on the review 510, and then enter the confidence score into the template at the time the template is established at 524 of method 500.

It is also a feature and aspect of the present disclosure to provide the ability for a merchant to track how customer attributes may change over time. Accordingly, method 500 may provide the feature of tracking change over time, by comparing attribute information received into the system at a time stamp 514, to additional attribute information received into the system at a subsequent time stamp 516.

At 514, the attribute data received into the system may be time stamped in order to provide the additional information about when a customer has entered attribute data. Time stamp data can be used to provide timeliness information about a customer for such uses as, for example, providing timely recommendations for seasonal items and services. At 516, subsequent time stamp data may be associated with additional attribute information received by the system.

At 518, the attribute change between the time stamp of 514 and 516 may be evaluated for quality and recorded in memory within computing environment 200 for later use by the system, or within the template. The information provided by a customer and the attribute change data provided at 518 may then be evaluated 520 for quality such that a confidence score may be assigned 522 based on the quality of the attributes and the change of the attributes overtime.

At 523, the life history attributes may be retrieved from memory on a merchant's server within computing environment 200. The life history attributes may have been entered by the customer previously, or may be entered concurrently with the notification for conveyance at 502. In an implementation, attributes that may be used in a template may be derived from documents provided by the customer that have been saved in the memory on a merchant's server.

At 524, a template may then be established that is correlated to a form as specified by the customer for the designated recipient. In other words, a customer may desire that a designated recipient only receive a certain category of attributes representing the customer's life history. Furthermore, a customer may wish to have the attributes organized in a certain way within the template.

It should be noted that the template may be organized by category of attribute such as, for example, demographics, personally identifiable information (PII), interests, work, clubs and any other category that may be useful in a template that is to be conveyed to a recipient. Additionally, in an implementation a customer may be presented with all of the attributes and customer items that the merchant has for the customer, and the customer designates the attributes and items for inclusion in the template to best represent a life history that is relevant to the recipient.

Additionally, the template may comprise the notification recorded into memory within computing system 200, the designated recipients recorded into memory, and the duration of access recorded into memory, change over time information, a confidence score regarding the change over time, and a confidence score for attribute quality. In an implementation, it may be desirable for the merchant to provide the confidence scores within the template, while in another implementation the confidence score may not be provided to customer or any third party recipients.

Once the template has been established as discussed above, the method may then fill in the template with the desired attributes and attribute information at 526. At 528, access may then be granted to the designated recipients and at 530 a clock begins to run for the duration of time designated at 506 of method 500. The clock may run automatically within the computing system of a network and the clock may be a commonly used timing circuit within the computing system. At 532, access to the template may be closed once the duration of time has elapsed as discussed above. In an implementation wherein a plurality of recipients is designated, each of the recipients may have different limitations of access to the template, such that the method may comprise a plurality of limiting factors that determine when access is closed for each recipient. Accordingly, the limiting factor for each recipient may be recorded in memory and associated with the provision of the template for each recipient. In other words a plurality of templates containing the same life history attributes may be established so that there is a template for each recipient.

Thus the disclosure provides a method and system for establishing a template for conveying customer attributes by considering the desires and the characteristics of third party recipients' and customers. Additionally, the disclosure allows a customer to specify the form of the template before it is shared to a designated third party. The disclosure also provides for the templates to comprise confidence scores for the attributes therein, and allows attributes of the template to be evaluated over time.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for establishing a template of customer attributes for access by a recipient, comprising:
receiving a notification from a customer requesting that an attribute in a customer profile representative of that customer be made available to a recipient in a template;
receiving a designation of a recipient for access made by the customer;
storing the designation of the recipient in memory of a server;
retrieving from memory attributes of the customer representing a life history of the customer;
establishing the template for the attributes of the customer having a layout of information as specified by the customer;
wherein the template comprises attributes representing the life history of the customer retrieved from memory and wherein the attributes within the template correspond to a characteristic of the recipient; and
providing access to the recipient.

2. A method according to claim 1, further comprising receiving a duration of access that the customer would like the template to be available for access by the recipient.

3. A method according to claim 2, further comprising denying access to the recipient when the duration of access has elapsed.

4. A method according to claim 1, further comprising receiving a number of accesses that the recipient is allowed to access the template.

5. A method according to claim 4, further comprising denying access to the recipient when the recipient has accessed the template equal to the number accesses specified by the customer.

6. A method according to claim 1, wherein the template is predetermined to comprise the following attributes: age of customer, education of customer, income of customer, photo of customer, gender of customer.

7. A method according to claim 1, wherein the template is predetermined not to contain an actual name and contact attributes for the customer.

8. A method according to claim 1, further comprising:
presenting to the customer a selectable selection of customer items that contain customer attributes that have been provided by the customer;
receiving a selection of customer items made by the customer; and
evaluating the items selected by the customer for customer attributes.

9. A method according to claim 1, further comprising: organizing the template on a display such that the recipient is presented with the template in the same layout that is displayed on the display as viewed by the customer.

10. A method according to claim 1, further comprising:
evaluating the attributes for quality;
providing a confidence score corresponding to quality and providing the recipients access to the confidence score.

11. A system for establishing a template of customer attributes for access by a recipient, comprising: one or more processors and one or more memory devices operably coupled to the one or more processors and storing executable and operational data, the executable and operational data effective to cause the one or more processors to:
receive a notification from a customer requesting that an attribute in a customer profile representative of that customer be made available to a recipient in a template;
receive a designation of a recipient for access made by the customer;
store the designation of the recipient in memory of a server;
retrieve from memory attributes of the customer representing a life history of the customer;
establish the template for the attributes of the customer having a layout of information as specified by the customer;
wherein the template comprises attributes representing the life history of the customer retrieved from memory and wherein the attributes within the template correspond to a characteristic of the recipient; and
provide access to the recipient.

12. A system according to claim 11, further comprising receiving a duration of access that the customer would like the template to be available for access by the recipient.

13. A system according to claim 12, further comprising of denying access to the recipient when the duration of access has elapsed.

14. A system according to claim 11, further comprising receiving a number of accesses that the recipient is allowed to access the template.

15. A system according to claim 14, further comprising denying access to the recipient when the recipient has accessed the template equal to the number accesses specified by the customer.

16. A system according to claim 11, wherein the template is predetermined to comprise the following attributes: age of customer, education of customer, income of customer, photo of customer, gender of customer.

17. A system according to claim 11, wherein the template is predetermined not to contain an actual name and contact attributes for the customer.

18. A system according to claim 11, further comprising:
present to the customer a selectable selection of customer items that contain customer attributes that have been provided by the customer;
receive a selection of customer items made by the customer; and
evaluate the items selected by the customer for customer attributes.

19. A system according to claim 11, further comprising: organize the template by the customer on a display such that the recipient is presented with the template in the same layout that is displayed on the display as viewed by the customer.

20. A system according to claim 11, further comprising:
evaluate the attributes for quality;
provide a confidence score corresponding to quality and providing the recipients access to the confidence score.
